(19) United States
(12) Patent Application Publication
(10) Pub. No.: US 2025/0184125 A1
(43) Pub. Date: Jun. 5, 2025

(54) IMPROVED QKD ARRANGEMENT

(71) Applicant: British Telecommunications Public Limited Company, London Greater London (GB)

(72) Inventor: Andrew LORD, London Greater London (GB)

(21) Appl. No.: 18/992,914

(22) PCT Filed: Jun. 13, 2023
(86) PCT No.: PCT/EP2023/065773

§ 371 Date: Jan. 9, 2025

(30) Foreign Application Priority Data
Jul. 12, 2022 (EP) 22184330.3

(51) Int. Cl. H04L 9/08

(52) U.S. Cl. CPC H04L 9/0852

(57) ABSTRACT

There is herein disclosed an apparatus for performing quantum key distribution, the apparatus comprising a plurality of connected functional components which, in use, co-operate to perform quantum key distribution, wherein one or more of the plurality of functional components are functionally disconnectable from, and re-connectable to, the remainder of the plurality of functional components.

Quantum Key Distribution (QKD) is a method of establishing a secret key using the principles of quantum mechanics. Its importance as a cryptographic technique is growing. One reason for this is concern over the potential power of quantum computing as an encryption-breaking technique.

QKD requires the preparation of information in quantum states. Specialist equipment is required to produce such quantum states and the equipment involved needs to be cooled. This results in systems being expensive to provide and run. It is desirable to decrease the cost associated with such systems.

It would be desirable to provide a QKD apparatus which overcomes and/or substantially mitigates some or all of the above-mentioned and or other drawbacks of the prior art.

According to a first aspect of the invention there is provided an apparatus for performing quantum key distribution, the apparatus comprising:
a plurality of connected functional components which, in use, co-operate to perform quantum key distribution,
wherein one or more of the plurality of functional components are functionally disconnectable from, and re-connectable to, the remainder of the plurality of functional components.

In known arrangements the components of QKD terminals are provided upon a single integral circuit board. In contrast, according to embodiments of present invention the plurality of functional components are disconnectable. This enables, for example, components of a QKD terminal to be replaced if found to be faulty or if an upgraded version of the component is available. Thus the cost of replacing the whole transmitter is avoided. By “functionally disconnectable from” it is meant that the component can be disconnected such that it can no longer function as part of the apparatus for performing QKD.

The apparatus may be a quantum transmitter or may be a quantum receiver or both. The apparatus may be adapted to perform quantum key distribution in accordance with any QKD protocol, e.g prepare-and-measure protocols, quantum entanglement protocols etc. The plurality of connected functional components may, in use, co-operate to prepare a quantum state for transmission in accordance with a quantum key distribution protocol. One or more components may be connected to one or more other components by optical fibre and/or metallic wire. The optical fibre and/or metallic wire may be provided with connectors to connect to the components. Such connectors may be received within corresponding sockets in the one or more components. Some of the components may communicate via free space.

The apparatus may further comprise one or more replacement functional components adapted to connect to the remainder of the plurality of functional components if the one or more of the plurality of functional components are disconnected from the remainder of the plurality of functional components.

If disconnected from the remainder of the plurality of functional components, the one or more of the plurality of functional components may be re-connectable to the remainder of the plurality of functional components.

As the skilled person would understand, a functional component in the context of a QKD apparatus is a component of the QKD apparatus that functionally contributes to the establishment of a quantum key. In embodiments in which the apparatus is a quantum transmitter, the plurality of functional components may comprise one or more of the following:
a source of photons;
a modulator;
control electronics;
a random number generator.

The source of photons may be a laser or may be a single photon transmitter. The source of photons may be connected to the modulator by an optical fibre such that the source of photons can transmit photons to the modulator over the optical fibre. The control electronics may be connected to the random number generator by metallic wire such that the random number generator can transmit a signal over the metallic wire to the control electronics indicative of a generated random number. The control electronics may be connected by respective metallic wire connections to the source of photons and the modulator. The quantum transmitter may further comprise a key establishment module for establishing the quantum key over a classical channel in accordance with QKD protocols. The control electronics may be connected by a metallic wire connection to a key establishment module.

In embodiments in which the apparatus is a quantum receiver, the plurality of functional components may comprise one or more of the following:
a demodulator;
control electronics;
a first photodetector;
a second photodetector.

The control electronics may be connected by respective metallic wire connections to the demodulator and to the first and second photodetectors. The demodulator may be connected by respective optical fibres to the first and second photodetectors. The quantum receiver may further comprise a key establishment module for establishing the quantum key over a classical channel in accordance with QKD protocols. The control electronics may be connected by a metallic wire connection to the key establishment module.

### Modular Components

The one or more of the plurality of functional components may be separable from the remainder of the plurality of functional components. In preferred embodiments, each of the plurality of functional components is separable from the remainder of the plurality of functional components. The one or more of the plurality of functional components may be provisioned in a separate module from the remainder of the plurality of functional components. In preferred embodiments, each of the plurality of functional components are provisioned in a separate module. The one or more of the plurality of functional components may be provided on a separate circuit board to one or more of the remainder of the plurality of functional components. The separate module may be located remotely from the remainder of the plurality of functional components and be connected to the remainder of the plurality of functional components.

### Shared Components

In some embodiments, one or more of the plurality of connected functional components is further connected to one or more further QKD apparatuses. The one or more of the plurality of connected functional components may be provisioned in a separate module which may be spaced apart from the remainder of the plurality of functional components of the QKD apparatus and may be spaced apart from the one or more further QKD apparatuses. The separate module may be connectable to the remainder of the plurality of functional components of the QKD apparatus and/or the one or more further QKD apparatuses by optical fibre and/or metallic wiring and/or free space. The one or more of the plurality of connected functional components may be disconnectable from the remainder of the plurality of functional components of the QKD apparatus and may be disconnectable from the one or more further QKD apparatuses.

These embodiments are advantageous as, e.g., the functionality of certain components can be shared between multiple QKD apparatuses. In embodiments where the QKD apparatus is a quantum transmitter, the one or more of the plurality of connected functional components may comprise a control electronics module and/or a random number generator. In some embodiments a single control electronics module and/or a random number generator serve a plurality of transmitter assemblies each having a photon source and a modulator. In embodiments where the QKD apparatus is a quantum receiver, the one or more of the plurality of connected functional components may comprise a control electronics module. The control electronics module may server a plurality of receiver assemblies each having a demodulator and first and second detectors.

The QKD apparatus may be located in a quantum node. A plurality of QKD apparatuses in accordance with the invention may be located in the quantum node. The quantum node may comprise one or more further quantum transmitters and one or more further quantum receivers.

In embodiments where the QKD apparatus is a quantum transmitter, the one or more of the plurality of connected functional components is further connected to one or more quantum receivers. In embodiments where the QKD apparatus is a quantum receiver, the one or more of the plurality of connected functional components is further connected to one or more quantum transmitters.

According to a further aspect of the invention there is provided a system for performing quantum key distribution, the system comprising:
A quantum transmitter having a first plurality of connected functional components which, in use, co-operate to perform quantum key distribution with the quantum receiver,
A quantum receiver having a second plurality of connected functional components which, in use, co-operate to perform quantum key distribution with the quantum transmitter,
wherein one or more of the first and/or second plurality of functional components are functionally disconnectable from, and re-connectable to, the remainder of that plurality of functional components.

A specific embodiment of the invention will now be described, for illustration only, and with reference to the appended drawings, in which:

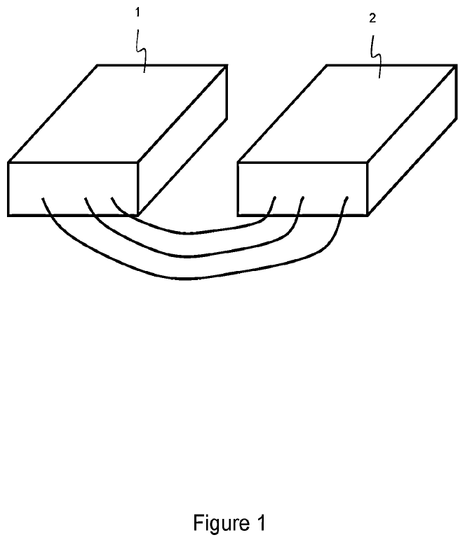

FIG. 1 is a 3D schematic view of a known QKD transmitter and receiver;

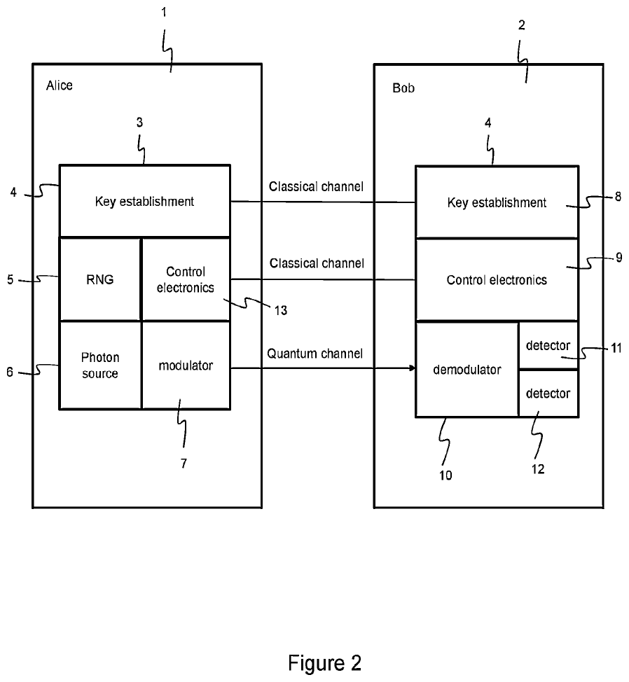

FIG. 2 is a schematic view of a known QKD transmitter and receiver;

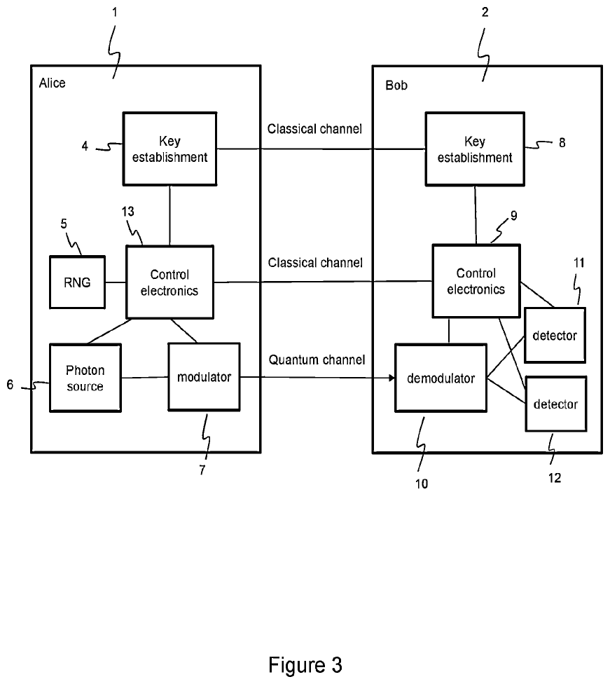

FIG. 3 is a schematic view of a QKD transmitter and receiver in accordance with the invention;

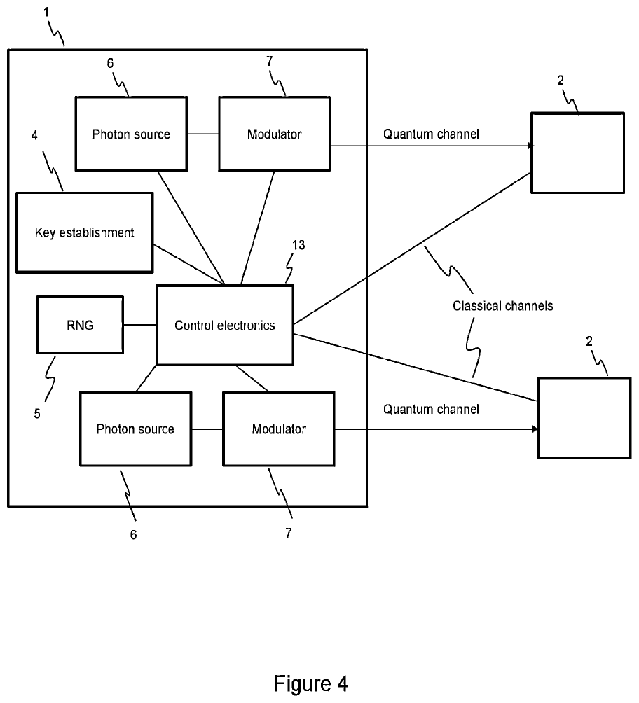

FIG. 4 is a schematic view of a QKD transmitter in accordance with an embodiment of the invention;

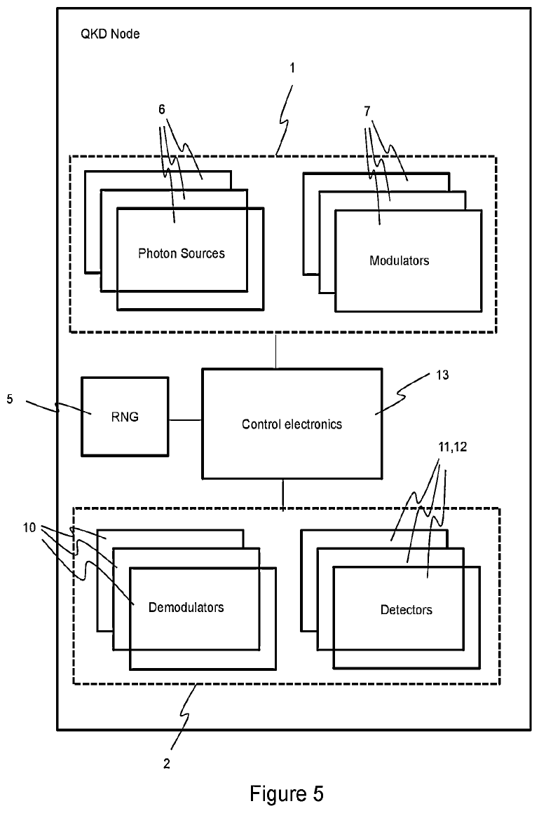

FIG. 5 is a schematic view of a QKD transmitter in accordance with a further embodiment of the invention.

FIG. 1 is a 3D schematic representation of a known QKD system. In particular, there is an Alice unit 1 (i.e. a quantum transmitter) and a Bob unit 2 (i.e. a quantum receiver). Alice 1 is connected to Bob 2 by three optical fibres representing a quantum channel and two classical channels respectively, as would be familiar to the skilled person.

The arrangement of FIG. 1 is shown in more detail in FIG. 2. In particular, FIG. 2 shows that Alice 1 contains a transmitter 3 and Bob 2 contains a receiver 4. Transmitter module 3 comprises several component elements. These are a key establishment element 4, random number generator 5, control electronics 13, laser photon source 6 and quantum modulator 7. Transmitter 3 is a chip and these component elements are written on the chip. The transmitter 3 is a single unitary object. The component elements are not separate from each other, nor are they separable or reconnectable.

The receiver 4 of Bob 2 comprises several component elements. These are a key establishment element 8, control electronics 9, quantum demodulator 10 and photo detectors 11 and 12. Receiver 4 is a chip and these component elements are written on the chip. The receiver 4 is a single unitary object. The component elements are not separate from each other, nor are they separable or reconnectable.

As the skilled person would understand, in use the random number generator in the transmitter module 3 of Alice 1 generates a random number. The control electronics 13 inputs the random number to modulator 7. The photon source 6 generates a photon and outputs it to the modulator which, using the random number prepares a quantum state for transmission. This is a qubit having a randomly-chosen encoded value of 0 or 1, prepared in a randomly-chosen basis state. This quantum state is transmitted to Bob 2 which, using the demodulator 10 and detectors 11 and 12, measures the quantum state in a randomly-chosen basis state. If the basis state in which Bob measures the quantum state is the same as that which Alice 1 used to prepare the quantum state, then Bob's detectors will measure the bit value that Alice encoded onto the photon correctly. If the basis state in which Bob 2 measures the quantum state is different to that Alice used to prepare the quantum state, then Bob's detectors may not measure the bit value that Alice encoded onto the photon correctly. This photon transmission process is repeated for multiple photons. Alice then transmits to Bob over one of the classical channels, a list of the basis states she used to prepare the photons. Bob sends Alice a list of the basis states he used to measure the photons. Alice and Bob then each discard the bit values in respect of the photons for which Alice and Bob used different basis states. Alice and Bob are then left with identical lists of bit values (i.e. the bit values encoded onto the photons in respect of which Alice and Bob used the same basis states). Alice and Bob then use these two identical lists as a quantum-encrypted key for secret communication.

FIG. 3 is a schematic view of an embodiment according to the invention. FIG. 3 contains Alice 1 and Bob 2 along with all of the component elements 4,5,6,7 of Alice and Bob that are shown in FIG. 2. These components have the same reference numerals as in FIG. 2. The difference between FIG. 3 and FIG. 2 is that in FIG. 3, the component elements are not part of unitary transmitter/receiver, marked as 3 and 4 respectively in FIG. 2. Instead, the components in FIG. 3 are separate and spaced apart from each other. They are connected to each other by optical fibre or wiring as appropriate. The optical fibres or wiring are provided with connectors which are received within corresponding sockets in the components. Such connections are familiar to the skilled person and so will not be described in detail here.

In particular, starting with Alice 1, control electronics 13 is connected by wiring to key establishment module 4, random number generator 5, photon source 6 and modulator 7. Control electronics 13 receives inputs and provides outputs to the other components over the wiring in the same way as in FIG. 2. Similarly, as in FIG. 2, photon source 6 transmits photons to modulator 7. However in FIG. 3, this transmission takes place via optical fibre. Similarly, at Bob 2, control electronics 9 communicates with the other components in Bob 2 via wiring in FIG. 3. Furthermore, demodulator 10 directs received photons to detectors 11 and 12 via optical fibre.

The component elements 4, 5, 6, 7, 13 of Alice 1 can be disconnected and removed from Alice 1, and once removed, can be reconnected to Alice 1. Thus if one of the component elements 4, 5, 6, 7, 13 of Alice were to break, or needed to be replaced by a newer model, such replacement is possible. Similarly, the component elements 8, 9, 10, 11 and 12 of Bob 2 can be disconnected and removed from Bob 2, and once removed, can be reconnected to Bob 2.

FIG. 4 shows a further arrangement according to the invention. Again, like components have the same reference numerals as in FIGS. 2 and 3. In FIG. 4 there is one Alice 1 and two Bobs 2. In FIG. 4, the control electronics 13, the random number generator 5 and the key establishment element 4 are shared by two photon source/modulator pairs 6,7. Each of the two photon source/modulator pairs 6,7 has its own quantum channel connecting the two modulators 7 to the two Bobs respectively. Furthermore, a respective classical channel extends from the control electronics 13 to each of Bobs 2. Thus, QKD can be performed by Alice 1 and Bobs 2 in which Alice contains only one control electronics element 13, random number generator 5 and the key establishment element 4. This sharing of components brings cost savings.

FIG. 5 is a schematic view of a QKD node containing multiple Alice 1 and a Bob 2 units. Each Alice 1 contains a photon source 6 and a modulator 7. Each Bob contains a demodulator 10 and detectors 11, 12. The multiple Alice 1 and Bobs 2 are served by a single random number generator 7 and a single control electronics unit 13. This illustrates how components can be shared between Alice and Bob units in a quantum node.

1. An apparatus for performing quantum key distribution, the apparatus comprising:
a plurality of connected functional components which, in use, co-operate to perform quantum key distribution,
wherein one or more of the plurality of functional components are functionally disconnectable from, and re-connectable to, the remainder of the plurality of functional components.

2. An apparatus according to claim 1, in which the one or more of the plurality of functional components comprises a socket adapted to connect to an optical fibre or a metallic wire.

3. An apparatus according to claim 1, in which the apparatus further comprises one or more replacement functional components adapted to connect functionally to the remainder of the plurality of functional components if the one or more of the plurality of functional components are disconnected from the remainder of the plurality of functional components.

4. An apparatus according to claim 1, in which the apparatus is a quantum transmitter.

5. An apparatus according to claim 4, in which the plurality of connected functional components comprises one or more of the following:
a source of photons;
a modulator;
control electronics;
a random number generator.

6. An apparatus according to any of claims 1 to 3 claim 1, in which the apparatus is a quantum receiver.

7. An apparatus according to claim 6, wherein the plurality of functional components comprises one or more of the following:
a demodulator;
control electronics;
a first photodetector;
a second photodetector.

8. A system for performing quantum key distribution, the system comprising:
A quantum transmitter having a first plurality of connected functional components which, in use, co-operate to perform quantum key distribution with the quantum receiver,
A quantum receiver having a second plurality of connected functional components which, in use, co-operate to perform quantum key distribution with the quantum transmitter,
wherein one or more of the first and/or second plurality of functional components are functionally disconnectable from, and re-connectable to, the remainder of that plurality of functional components.
